(19) United States
(12) Patent Application Publication
(10) Pub. No.: US 2014/0207629 A1
(43) Pub. Date: Jul. 24, 2014

(54) SYSTEM, METHOD, AND APPARATUS FOR IDENTIFYING AND AUTHENTICATING THE PRESENCE OF HIGH VALUE ASSETS AT REMOTE LOCATIONS

(71) Applicant: THE TB GROUP, INC., Golden Eagle, IL (US)

(72) Inventors: A.W. (Tony) Bradley, Golden Eagle, IL (US); Keith W. McCord, Florissant, MO (US)

(73) Assignee: THE TB GROUP, INC., Golden Eagle, IL (US)

(21) Appl. No.: 14/159,974

(22) Filed: Jan. 21, 2014

Related U.S. Application Data
(60) Provisional application No. 61/849,185, filed on Jan. 22, 2013.
(60) Provisional application No. 61/849,186, filed on Jan. 22, 2013.
(60) Provisional application No. 61/849,184, filed on Jan. 22, 2013.
(60) Provisional application No. 61/849,183, filed on Jan. 22, 2013.
(60) Provisional application No. 61/849,182, filed on Jan. 22, 2013.
(60) Provisional application No. 61/849,187, filed on Jan. 22, 2013.
(60) Provisional application No. 61/849,963, filed on Feb. 5, 2013.
(60) Provisional application No. 61/849,962, filed on Feb. 5, 2013.
(60) Provisional application No. 61/849,961, filed on Feb. 5, 2013.
(60) Provisional application No. 61/849,960, filed on Feb. 5, 2013.
(60) Provisional application No. 61/851,079, filed on Feb. 28, 2013.
(60) Provisional application No. 61/851,080, filed on Feb. 28, 2013.
(60) Provisional application No. 61/851,081, filed on Feb. 28, 2013.
(60) Provisional application No. 61/854,160, filed on Apr. 18, 2013.

(51) Int. Cl. G06Q 10/08

(52) U.S. Cl. CPC G06Q 10/087
USPC 705/28

(57) ABSTRACT

A method includes providing an electronic module configured to retrieve vehicle specific data associated with a vehicle, obtaining the vehicle specific data from the vehicle using the electronic module, and wirelessly bi-directionally communicating the vehicle specific data with a mobile device(s) near the vehicle. A system includes providing an electronic module configured to retrieve vehicle specific data associated with a vehicle, wherein the electronic module bi-directionally communicates the vehicle specific data while the electronic module is interfaced with the vehicle and only while the electronic module is interfaced with the vehicle.

### CROSS-REFERENCE TO RELATED APPLICATIONS

U.S. Provisional Application Ser. No. 61/849,185, System, Method, And Apparatus No. 1 For Identifying And Authenticating The Presence Of High Value Assets At Remote Locations, filed Jan. 22, 2013.

U.S. Provisional Application Ser. No. 61/849,186, System, Method, And Apparatus No. 2 For Identifying And Authenticating The Presence Of High Value Assets At Remote Locations, filed Jan. 22, 2013.

U.S. Provisional Application Ser. No. 61/849,184 System, Method, And Apparatus No. 3 For Identifying And Authenticating The Presence Of High Value Assets At Remote Locations, filed Jan. 22, 2013.

U.S. Provisional Application Ser. No. 61/849,183 System, Method, And Apparatus No. 4 For Identifying And Authenticating The Presence Of High Value Assets At Remote Locations, filed Jan. 22, 2013.

U.S. Provisional Application Ser. No. 61/849,182 System, Method, And Apparatus No. 5 For Identifying And Authenticating The Presence Of High Value Assets At Remote Locations, filed Jan. 22, 2013.

U.S. Provisional Application Ser. No. 61/849,187 System, Method, And Apparatus No. 6 For Identifying And Authenticating The Presence Of High Value Assets At Remote Locations, filed Jan. 22, 2013.

U.S. Provisional Application Ser. No. 61/849,963 System, Method, And Apparatus No. 7 For Identifying And Authenticating The Presence Of High Value Assets At Remote Locations, filed Feb. 5, 2013.

U.S. Provisional Application Ser. No. 61/849,962 System, Method, And Apparatus No. 8 For Identifying And Authenticating The Presence Of High Value Assets At Remote Locations, filed Feb. 5, 2013.

U.S. Provisional Application Ser. No. 61/849,961 System, Method, And Apparatus No. 9 For Identifying And Authenticating The Presence Of High Value Assets At Remote Locations, filed Feb. 5, 2013.

U.S. Provisional Application Ser. No. 61/849,960 System, Method, And Apparatus No. 10 For Identifying And Authenticating The Presence Of High Value Assets At Remote Locations, filed Feb. 5, 2013.

U.S. Provisional Application Ser. No. 61/851,079 System, Method, And Apparatus No. 11 For Identifying And Authenticating The Presence Of High Value Assets At Remote Locations, filed Feb. 20, 2013.

U.S. Provisional Application Ser. No. 61/851,080 System, Method, And Apparatus No. 12 For Identifying And Authenticating The Presence Of High Value Assets At Remote Locations, filed Feb. 28, 2013.

U.S. Provisional Application Ser. No. 61/851,081 System, Method, And Apparatus No. 13 For Identifying And Authenticating The Presence Of High Value Assets At Remote Locations, filed Feb. 28, 2013.

U.S. Provisional Application Ser. No. 61/854,160 System, Method, And Apparatus No. 14 For Identifying And Authenticating The Presence Of High Value Assets At Remote Locations, filed Apr. 18, 2013.

All the aforementioned provisional patent applications are hereby incorporated by reference in their entirety.

### FIELD OF THE INVENTION

The present invention relates generally to a system, method and apparatus for various uses including, but not limited to, automatic or semi-automatic inventory/asset audits for dealers, original equipment manufacturers, owners, and financiers.

In addition, the present invention can be used as an aid in the management of storage and transportation logistics, sales force access to history and valuation reports, sales force access to product comparisons, granting permission for test drives, providing a means for post-sales connections of a dealer-to-customer-to-vehicle, and auto auction applications including, but not limited to, pre-sale reconditioning data, display and staging logistics, providing dealer access to history, valuation, and comparison reports, granting permission for dealer test drives, providing an auction recap to dealers and anti-fraud purposes, law enforcement vehicle verification, and for authenticating the identity, possession, genuine presence, and/or location of a high value asset, which may be encumbered, financed, “floor planned”, rented, leased, etc. A high value asset may be any vehicle, or piece of machinery that includes a diagnostic port, including, but not limited to, an automobile, truck, recreational vehicle, boat, motorcycle, construction equipment, agricultural equipment, mining equipment, manufacturing equipment, etc.

### Problems in the Art

Today, high value assets, particularly vehicles, machinery, equipment, or other dealer inventory which may be encumbered, financed, “floor planned”, rented, leased, etc., are difficult to track, authenticate, and audit. This is due to the fact they are widely geographically dispersed, mobile, can be easily converted to cash without possession of a title, and cannot be easily traced. Most generally it is inferred that possession is ownership, so it is difficult to determine who actually owns the high value asset. In most cases, in order for a high value asset, such as an automobile or truck to be properly audited, their identity must somehow be verified by conducting some type of physical inspection. This is usually accomplished by an agent traveling to a remote location to perform the on-site inspection.

Therefore, there is a need for a more efficient method of authenticating the genuine presence, identity and possession of, and automatically or semi-automatically auditing an asset. In addition, the present invention can be used to provide data necessary for maintaining a database related to that specific asset for the recording, storing, and retrieval of information related to the automatic or semi-automatic audit, and other functions such as, but not limited to, inventory control, repair work orders, vehicle auctions, targeted advertising, title history, customer loyalty programs, Customer Relationship Management (CRM), sales force automation, distribution control, logistics management, document control, voice and/or text communications, etc.

### Features of the Invention

A general feature of the present invention for transponder and/or wired plug-in vehicle services is the provision of a system, method, and apparatus, which overcomes many of the problems found in the prior art.

A further feature of the present invention is to provide for a device for use with a vehicle diagnostic in order to capture any suitable ID associated with a particular vehicle.

A further feature of the present invention is to eliminate the need for a third party to physically visit/audit any borrower location.

A further feature of the present invention is to provide the technology for lenders to complete accurate, efficient, and authentic audits of their collateralized assets at any borrower location.

A further feature of the present invention is to provide the capability of fully autonomous auditing and tracking of assets without the constraints of time or human interaction.

### SUMMARY OF THE INVENTION

The present invention for a transponder that can be plugged into the diagnostic port of an asset, relates generally to a system, method and apparatus for authenticating the genuine identity, actual possession, care, custody and control, and/or location of a high value asset, which may be encumbered, financed, “floor planned”, rented, leased, etc.

U.S. Pat. No. 7,774,268 describes a system, method, and apparatus for identifying and authenticating the presence of high value assets at remote location includes associating an identification tag with the asset. The identification tag includes identification information that can be electronically read and sent to a remote location for verifying the authenticity of the asset. This patent is hereby included by reference in its entirety.

In addition, data collected from the present invention's transponder can be used for various purposes including, management of storage and transportation logistics, sales force access to history and valuation reports, sales force access to product comparisons, granting permission for test drives, providing a means for post-sales connections of a dealer-to-customer-to-vehicle, and vehicle auction applications including, but not limited to, pre-sale reconditioning data, display and staging logistics, providing dealer access to history, valuation, and comparison reports, granting permission for dealer test drives, and providing an auction recap to dealers.

The preferred embodiment of the present invention's transponder is comprised of three basic components as a means for identifying a high value asset, including a transponder, an Integrated Interface Device (IID), and a back-end database. This is an integrated solution for the vehicle auction and vehicle sales industry that provides self-audit functionality and centralized database services. It is to be understood that the invention is not to be limited to the preferred embodiment.

In the preferred embodiment, authentication of the genuine presence of a vehicle is accomplished through the use of a unique transponder designed to emit a unique identifier associated with an asset, said identifier may be an alpha-numeric identifier, such as, but not limited to a Vehicle Identification Number (VIN), Calibration Identification (CALID), etc., which is obtained from a vehicle's systems communication port, such as, but not limited to the Onboard Diagnostic (OBD) port.

Onboard Diagnostics (OBD) is an automotive term referring to a vehicle's self-diagnostic and reporting capability. OBD systems give the vehicle owner or repair technician access to the status of the various vehicle sub-systems. The amount of diagnostic information available via OBD has varied widely since its introduction in the early 1980s' versions of on-board vehicle computers. Early versions of OBD would simply illuminate a malfunction indicator light or “idiot light” if a problem was detected but would not provide any information as to the nature of the problem. Modern OBD implementations use a standardized communications port to provide real-time data in addition to a standardized series of diagnostic trouble codes, or DTCs, which allow one to rapidly identify and remedy malfunctions within the vehicle. Modern OBD systems typically include a diagnostic connection port such as, but not limited to the SAE J1962 connector, which is where the present invention's transponder would be normally plugged into.

Globally, as a result of increasing emission levels around the world, many countries have enacted strict emission related regulations that will drive additional technology into the modern vehicles in order to reduce the exhaust emissions. European and North American countries lead the way by adopting technology that will standardize the way these vehicles can be checked for compliance.

The OBD-I (On-Board Diagnostics I) system was introduced in the early 1980s and by 1988 all new cars and light trucks sold in California had to have OBD-I. The fundamental elements of the OBD-I are the electrical components (which influence exhaust emissions) that are monitored by the engine management system. An optical warning signal is given in the event of an OBD-I relevant failure. This fault can be determined by way of a flashing code.

OBD-II has been compulsory on all vehicles in the US market since January 1996. EOBD (European On-Board Diagnostics) is the European equivalent to OBD-II. It was introduced in 2000 and became effective in January 2001. There are a few differences between EOBD and OBD-II, but none that will affect the present invention's generic scan tool operation. All the communication protocols for both programs are identical.

Vehicle emission strategies and certification procedures vary between countries, states and regions and always use the vehicle factory service information specific to the country and emission certification.

EURO-3 is a continuation of the emission regulations known as EURO-1 and EURO-2. In addition to introducing stricter emission limits, the directive now also covers the monitoring of emission related components and functions during operation, i.e. EOBD.

The OBD-II and EOBD system must show the failure of an emission related component or system, to the driver using a Malfunction Indicator Lamp (MIL).

For the Repair Shop, OBD-II and EOBD means that a universal or generic OBD-II/EOBD scan tool can now be used on any OBD-II 1996 and newer, and EOBD 2001 and newer vehicle, giving the shop more diagnostic coverage than was previously possible.

In the United States, generally there are three distinct time periods that can be mapped for querying vehicle specific identification through the On Board Diagnostic SAEJ1962 (OBD) port. These model year (MY) time period divisions for information queries are as follows:

MY2008 to Present—Vehicles manufactured from MY2008 and forward adhere to the bus protocol ISO15765 (CAN). Furthermore, vehicle identification information can be retrieved directly by querying the Vehicle Identification Number (VIN) and Calibration Identification (CALID) through OBD Mode $09 access.

MY2002 thru MY2007—Vehicles manufactured between MY2002 through MY2007 can support a variety of bus protocols including ISO15765 (CAN), J1850 PWM, J1850 VPW, and ISO9141/14230. During this time period, the manufacturers were not required to place specific VIN information through OBD Mode $09 access. When VIN information is available, it will be used. If the VIN information is not available in the OBD Mode $09 query, then the CALID is downloaded and compared to a database which will identify the vehicle's year, make, and model.

MY2002 and earlier—Vehicles manufactured prior to MY2002 can support a variety of bus protocols including J1850 PWM, J1850 VPW, and ISO9141/14230 and vehicles prior to MY1996 will not support OBDII protocols at all. Therefore, very little information regarding vehicle identification can be gathered directly through the OBD port query.

In order to use the present invention with as many vehicle model years as possible, there are different retrieval steps that will be used to ensure authenticity of a particular vehicle's identification. These steps are listed in the order that the information will be retrieved while connected to the OBD port. Once all the information in a particular step is successfully retrieved, the authentication is completed and no further steps are performed. If at any point within a particular authentication step fails, then the entire authentication step is deemed invalid and the next step is tested. The steps in order are as follows:

1. The vehicles authentication information is retrieved via the OBD diagnostic port or via the invention's volatile on-board memory and includes the connected vehicle's VIN and CALID. This information is uploaded to the authentication software (either cloud based, smartphone based, or personal computer based) while passing with it a time-stamp and location coordinates that are GPS based and/or internet time server and MAC address based.

2. If the vehicle's VIN is not available through the OBD diagnostic port directly, the CALID is captured through the OBD diagnostic port. This CALID is used to determine the year, make, and model of the vehicle. A photograph or short video is also taken to show the vehicle's odometer on the dashboard. This information is uploaded to the authentication software (either cloud based, smartphone based, or personal computer based) while passing with it a time-stamp and location coordinates that are GPS based and/or internet time server and MAC address based. If the authentication module is to be left in the vehicle for further queries, the determined VIN number based on matching the CALID information and photographs/video information to the requested asset audit is stored on the module in volatile memory for future queries such that Step 1 will be used. If the module is removed from the vehicle, this information is automatically erased from the module.

3. If the VIN and the CALID are not available through the OBD diagnostic port directly, then authentication of the vehicle will be performed using pictures or videos of the vehicle while the OBD module is plugged into the vehicle. A photograph or short video is also taken to show the vehicle's odometer on the dashboard, the VIN plate on the dashboard, and randomly determine picture(s) of the exterior of the vehicle from a given vantage point. While these pictures/videos are being taken the invention must remain plugged into the vehicle's OBD diagnostic port. This information is uploaded to the authentication software (either cloud based, smartphone based, or personal computer based) while passing with it a time-stamp and location coordinates that are GPS based and/or internet time server and MAC address based. If the authentication module is to be left in the vehicle for further queries, the determined VIN number based on matching the photographs/video information to the requested asset audit is stored on the module in volatile memory for future queries such that Step 1 will be used. If the module is removed from the vehicle, this information is automatically erased from the module.

The present invention's methods improve the ability to authenticate the identity of a vehicle back to the inception of the standard OBD-II diagnostic port in 1996.

The genuine presence of a vehicle may be verified by a secondary means of authentication, such as, but not limited to, a photograph of a VIN plate, odometer reading, license plate, etc. The present invention's transponder may transfer data obtained from a diagnostic module sonically, or via a port designed for connection to an Integrated Interface Device (IID) via a signal wire.

The authentication audit is performed using asset identifiers obtained through a transceiver, and may include a secondary means of identification integrated into a specialized piece of equipment, such as an IID. The IID may also be configured as a tablet, smart phone, or other device capable of receiving the present invention's transponder and/or wired plug-in signals. Optionally, the IID can be configured to transmit/receive data sonically, or via a wire.

In the preferred embodiment of the present invention, the IID can be a propriety device, or an enabled tablet, smart phone, or other device that can connect to a back-end computer stem. According to the specific type of means used to authenticate the presence of a high value asset, the IID will have the appropriate capability to receive a transponder signal. This technology may be further integrated with a transponder designed to emit a unique identifier associated with an asset, said identifier may be an alpha-numeric identifier, such as, but not limited to a Vehicle Identification Number (VIN), Calibration ID (CALID), which may use GPS, and/or cellular phone based location information, or any other wireless radio frequency location technology, to provide a secondary level of authentication to validate the genuine presence of a specific high value asset. An IID with GPS technology can also be used to record the location of a high value asset. The IID is also preferably capable of wireless voice and/or text-based communications over a local and/or global telecommunications network. The IID and transponders can be designed to interface with telecommunication networks that can be point-to-point, and/or peer-to-peer architectures.

The final component in the present invention is a database that can be used for recording, storing, and retrieval of information related to a specific high value asset for the purposes of identification, authentication, audit, etc. The database, which may be public or private, may be used for other related activities such as, but not limited to inventory control, repair work orders, vehicle auctions, government vehicle auctions, salvage vehicle auctions which process and sell salvage vehicles principally to licensed dismantlers, re-builders and used vehicle dealers, targeted advertising, title history, customer loyalty programs, Customer Relationship Management (CRM), sales force automation, distribution control, field force automation, logistics management, document control, voice and/or text communications, etc. The item specific information may reside in the IID device itself, and/or in a remote database.

The unique identifier, such as, but not limited to a VIN, CALID, etc., having been obtained from a vehicle's diagnostic port, and transmitted wirelessly by the present invention's transponder to an IID, and to a back-end database, allows many stakeholders to have access to the unique identifier associated with a vehicle, or piece of machinery, and related information simultaneously, such as, but not limited to real-time location, anytime, easier, and quicker than any other method.

In addition, with the VIN being obtained from a vehicle diagnostic port, and transmitted wirelessly by the present invention's transponder and/or wired plug-in with greater reliability than other scanning methods, will enhance existing applications that use a scanned VIN, and the present invention will result in data that will automatically produce an audit trail.

One of the biggest advantages using the present invention, is once the VIN, CALID, etc., is obtained from a vehicle onboard diagnostic port, and transmitted wirelessly by the present invention's transponder, stakeholders will be able to easily, and seamlessly access a webpage and/or cloud based database related to a particular vehicle's VIN, as a web browser or dedicated application on a cellphone to access various existing different applications, and applications of the present invention. Use of the present invention by the various stakeholders will create a behind-the-scenes audit trail that will be very useful intelligence that can be applied to sales efforts at an auction house, dealership, etc., and other uses as well.

In its basic form, the present invention will be a simple audit function where a vehicle dealer's employee is able to access the VIN from each vehicle independently as they walk the lot. The unique identifier, such as, but not limited to VINs, CALIDs, etc., for all the vehicles that are floor planned will be gathered by the dealers smartphone, and the resulting VINs will be forwarded to the present invention's service center to be compared to the database of what VINs should be present on a particular vehicle lot. Any exceptions will brought to the attention of the finance company for proper follow up with the dealer.

At an auto auction, or at the dealer's option, the necessary components to implement the present invention can be installed in all vehicles as needed, in order to provide many additional services to a dealer, such as, but not limited to, inventory control, etc.

The present invention is designed to provide a technology for lenders to complete accurate, efficient, and authentic audits of their collateralized assets at any borrower location.

Following is a practical example of the method that may be used in the present invention to perform a manual remote audit of an automobile sales lot. In this example, the IID is configured as a mobile device that connects wirelessly to the present invention's transponder which is plugged into a vehicle's OBD diagnostic port. Once an audit request is initiated, the borrower receives automatic notification from the present invention of the audit request. The borrower logs into the present invention web portal to review and either downloads the audit requirements to the mobile device or accesses the audit requirements directly through the mobile device application. The mobile device queries each transponder connected to an OBD diagnostic port, to capture a unique identifier associated with a vehicle, such as, but not limited to a VIN, CALID, etc., in order to ensure the authenticity of a vehicle being audited. Once the asset's unique identifier information is captured by the invention, this data is uploaded through the web/cloud portal interface on the mobile device, verified, and the physical audit is completed for that asset. The financier is automatically notified by the present invention that the audit is complete and can log-in to the web portal to review the audit results.

The basic architecture of the present invention consists of the following:

1. Web Server (Portal)—The web server functions as the database manager. All lender, borrower, and user information is securely maintained on the web server and all data transactions are processed by the web server.

2. Lender (Audit Manager) Web Portal—A subscribed Lender can administer all audit functionality through the Lender Web Portal. The Lender establishes user and borrower access, manages assets and import and export audit information.

3. Borrower Web Portal—A borrower facilitates audit requests from a lender through the Borrower Web Portal. The audit information is also uploaded and downloaded to the audit device through the Borrower Web Portal.

4. The present invention Audit Device—The Audit Device is utilized to retrieve the alpha-numeric identifier (authentic VIN and/or CALID) from each lender asset. Once the audit information is uploaded to the invention, the unique identification information is uploaded via the mobile device to the web server.

The following is the process flow of the initial lender setup with the present invention subscription through the first audit:
1) Lender receives administrator account information from the present invention sales
2) Lender Admin logs into the present invention portal and can manage Lender account information with the present invention
3) Lender Admin sets up internal audit user to perform audits
4) Lender User logs into system and sets up audit specific configurations
5) Lender User enters borrower information (Name, Location, Contact Info (email), etc.)
6) If this is the first time borrower has performed self-audits, the Lender sends invention to borrower and establishes borrower's access to web portal.
7) Lender User enters specific asset information (single VIN entry and multiple VIN upload)
8) Lender User determines audit requirement. Selects borrower, assets (can select all from specific dealer or identify specific asset) and required completion date
9) Borrower is automatically notified via contact information (email) submitted by Lender User (above).
10) Borrower logs into the present invention portal to review audit requirements, vehicle specifics (the present invention will decode the VIN) and may print the audit work order if desired.
11) Borrower performs physical audit using the invention and a mobile device whose results are uploaded through the web portal.
12) Borrower has exception screen to document any incomplete audits based upon lender audit configurations (Incomplete codes, comment field, etc.)
13) Borrower submits audit results of completed asset audits and any exceptions.
14) Lender User is automatically notified of audit completion (The user notified is specific to whom the audit was initiated by)
15) Lender User logs into portal and can review/export audit information

Following is a practical example of the method that may be used in the present invention to perform an autonomous remote audit of an automobile sales lot. In this example, the IID is configured as a mobile device that connects wirelessly to the present invention's transponder which is plugged into a vehicle's OBD diagnostic port. A peer to peer network of multiple inventions is established and each invention will retrieve unique asset information such as, but not limited to VIN and CALID. This unique asset information is gathered automatically or by request through a common router node located on the dealer lot and uploaded through the web portal to a cloud based database. The borrower can establish time frequency periods to automatically gather the asset information or can query specific assets for their information and status. The only interaction required by the dealer is to plug in the invention into the vehicle and initiate a onetime data capture. Any anomalies or discrepancies by the lender can trigger a manual or interactive audit of the asset.

The basic architecture of the present invention consists of the following:

1. Web Server (Portal)—The web server functions as the database manager. All lender, borrower, and user information is securely maintained on the web server and all data transactions are processed by the web server.

2. Lender (Audit Manager) Web Portal—A subscribed Lender can administer all audit functionality through the Lender Web Portal. The Lender establishes user and borrower access, manages assets and import and export audit information.

3. Borrower Web Portal—A borrower facilitates audit requests from a lender through the Borrower Web Portal. The audit information is also uploaded and downloaded to the audit device through the Borrower Web Portal.

4. The present invention Audit Device—The Audit Device is utilized to retrieve the alpha-numeric identifier (authentic VIN and/or CALID) from each lender asset. Once the audit information is uploaded to the invention, the unique identification information is uploaded to the web/cloud portal via common router connected to the peer to peer network.

The following is the process flow of the initial lender setup with the present invention subscription through the first audit:
1) Lender receives administrator account information from the present invention sales
2) Lender Admin logs into the present invention portal and can manage Lender account information with the present invention
3) Lender Admin sets up internal audit user to perform audits
4) Lender User logs into system and sets up audit information
5) Lender User enters borrower information (Name, Location, Contact Info (email), etc.)
6) If this is the first time borrower has performed self-audits, the Lender sends multiple inventions to borrower and establishes borrower's access to web portal.
7) Lender User enters specific asset information (single VIN entry and multiple VIN upload)
8) Lender User determines audit requirement including audit query frequency of assets for automatic reporting. The Lender can also initiate specific asset queries for either immediate or time specific automatic audit.
9) Autonomous audits are performed using the inventions and a dedicated router connected to the peer to peer network. The results are uploaded through the web/cloud portal.
10) Lender has exception screen to document any incomplete audits based upon audit configurations (Incomplete codes, comment field, etc.)
11) Lender submits audit results of completed asset audits and any exceptions.
12) Lender can request further audits on assets or request that borrower perform a manual audit on specific assets.

According to one aspect a method includes providing an electronic module configured to retrieve vehicle specific data associated with a vehicle, obtaining the vehicle specific data from the vehicle using the electronic module, and wirelessly bi-directionally communicating the vehicle specific data with a mobile device(s) near the vehicle. The electronic module may be configured to retrieve data from an OBD port of the vehicle through the OBD port. The vehicle specific data may include a vehicle identification number (VIN) and/or calibration identification (CALID) data. The method may further include inserting the electronic module into the vehicle, sending vehicle specific data to the electronic module, and storing the vehicle specific data in the electronic module while the electronic module is in the vehicle such that the vehicle specific data is not present when the electronic module is removed from the vehicle. The vehicle may provide power to the electronic module while the electronic module is connected to the vehicle. The method may further include analyzing the vehicle specific data such as to determine whether or not a party to a financing agreement is in compliance with the financing agreement using the vehicle specific data. The analyzing may further provide for inventory control, inventory mapping, or theft deterrence of vehicles regardless of the financing status of the vehicle. The method may further include providing a mobile app for use on the mobile devices, wherein the mobile app is configured to use the vehicle specific data as input. The method may further include receiving the vehicle specific data as input into the mobile app and communicating the vehicle specific data over a communications network to a remote server. The method may further include performing a remote audit using the vehicle specific data. The method may further include acquiring photographs or videos of the vehicle using one or more of the mobile devices near the vehicle and communicating the photographs or videos of the vehicle to the remote server. The method may further include performing a remote audit using the vehicle specific data and the photographs or the videos. The remote server may provide both a lender portal and a borrower portal.

According to another aspect, a system is provided. The system includes providing an electronic module configured to retrieve vehicle specific data associated with a vehicle, wherein the electronic module bi-directionally communicates the vehicle specific data while the electronic module is interfaced with the vehicle and only while the electronic module is interfaced with the vehicle. The method may further include interfacing the electronic module to the vehicle and communicating the vehicle specific data from the vehicle to a cloud-based server. The step of communicating the vehicle specific data from the vehicle to the cloud-based server may include wirelessly communicating the vehicle specific data to the cloud-based server through a wireless router in operative communication with the electronic module. The communicating may include wirelessly communicating the vehicle specific data to a mobile device executing a mobile app and wirelessly communicating the vehicle specific data through the mobile app to the cloud-based server. Where used, the mobile app may be further configured to receive photos and/or videos of the vehicle and communicate the photos and/or videos of the vehicle to the cloud-based server.

### BRIEF DESCRIPTION OF THE DRAWINGS

FIG. 1A is an illustration of the present invention's transponder designed to emit a unique identifier associated with an asset.

FIG. 1B is an illustration of an alternative embodiment of the present invention's transponder designed to emit a unique identifier associated with an asset.

FIG. 2 is an illustration of the present invention's Integrated Interface Device (IID) contained in a single device.

FIG. 3A is an illustration of the system of the present invention.

FIG. 3B is an illustration of the system of an alternative embodiment of the present invention.

### DETAILED DESCRIPTION OF THE PREFERRED EMBODIMENTS

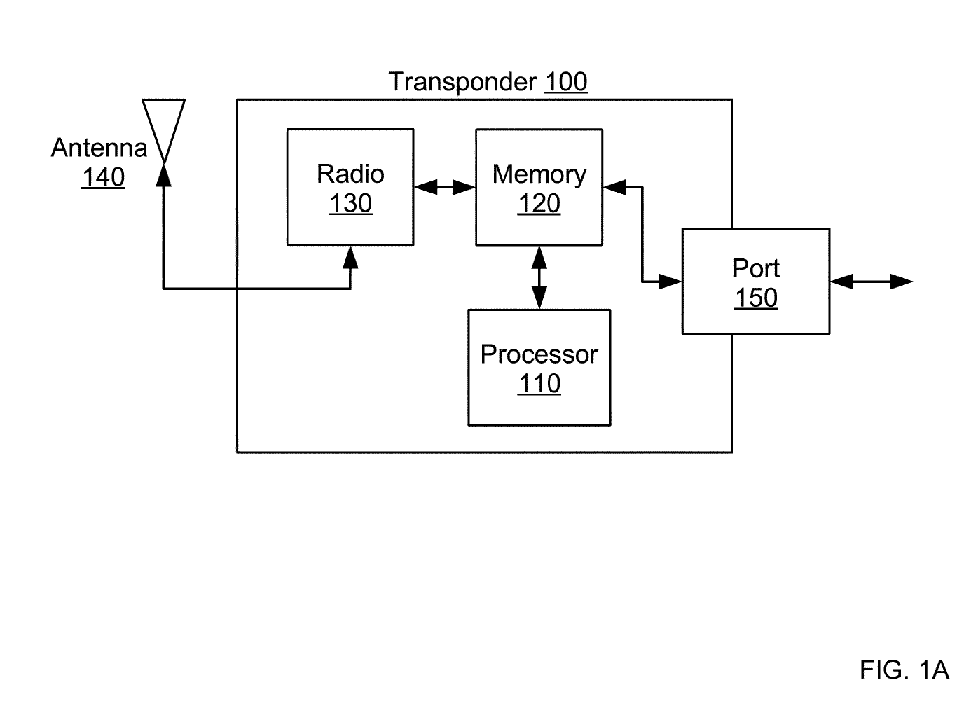

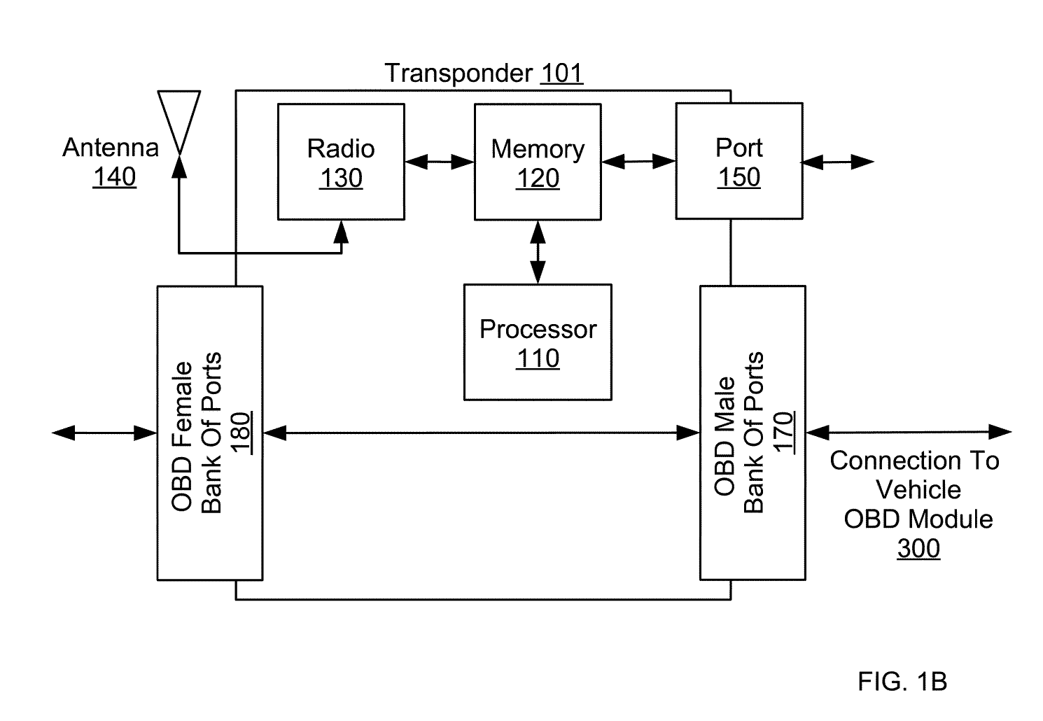

FIG. 1A illustrates an embodiment of Transponder 100 of the present invention, designed to emit a unique identifier associated with an asset that is part of the integrated solution described in the present invention for transponder-based vehicle services. Transponder 100 may be designed to include its own unique identifier, such as, but not limited to, MAC-48 addresses, EUI-64 addresses, IP addresses, RFID identifiers, Electronic Serial Numbers (ESN), International Mobile Equipment Identifiers (IMEI), Mobile Equipment Identifiers (MEI), International Mobile Subscriber Identity (IMSI), etc. Transponder 100s unique identifier may be cross-referenced to a vehicle's unique identifier, such as, but not limited to, a VIN, CALID, etc. The unique identifier of Transponder 100 may be the only unique identifier collected in an audit, which is cross-referenced by the method of the present invention to the associated unique identifier of the associated vehicle, or piece of machinery.

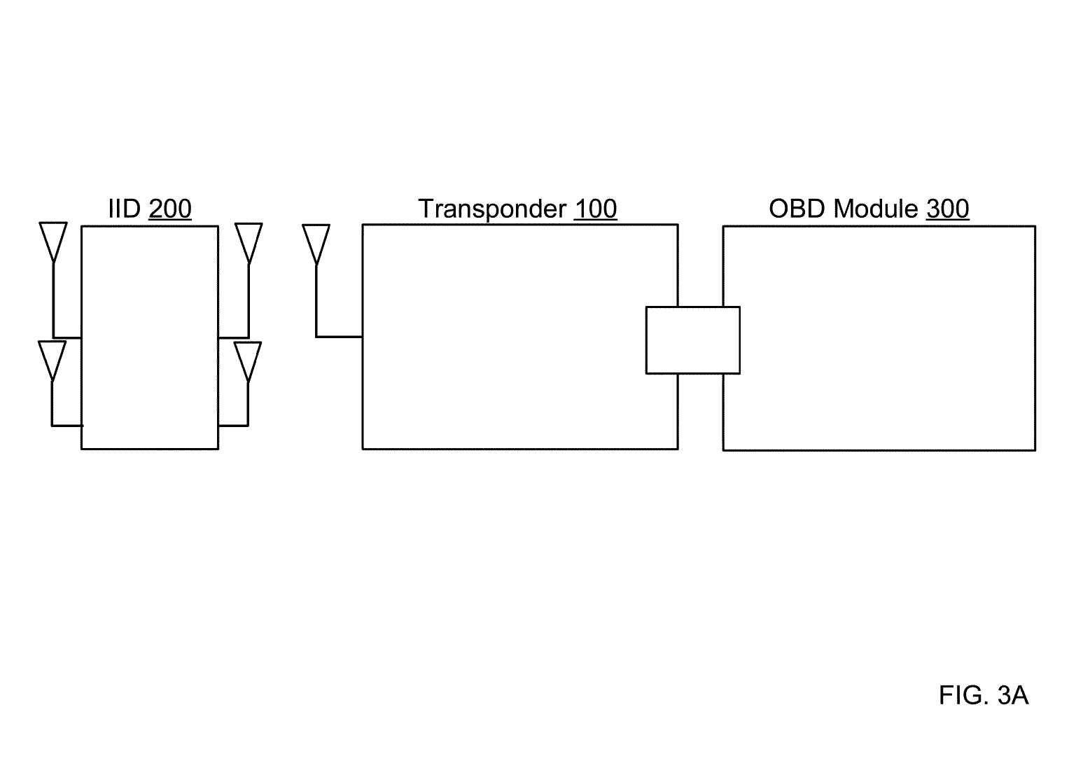

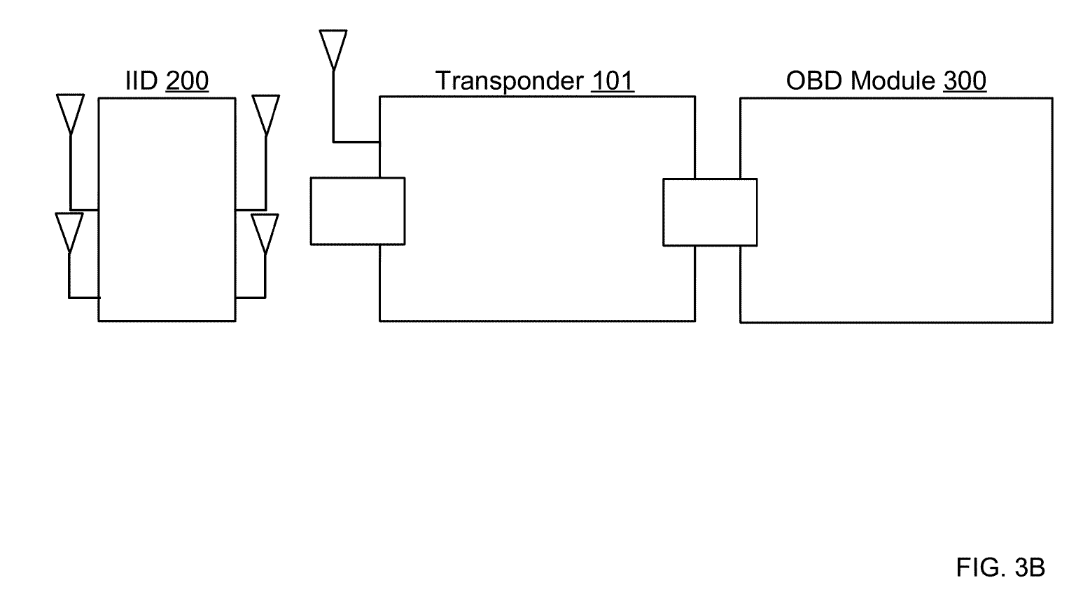

Transponder 100 is designed to be inserted into a port on a vehicle OBD module (as shown in FIGS. 3A, 3B).

Transponder 100 consists of the following components, processor 110, memory 120, radio 130, antenna 140, and port 150.

Processor 110 incorporates the functions of a central processing unit (CPU) on at least one integrated circuit. Processor 110 accepts digital data as input, processes it according to instructions stored in memory 120, and provides results as output.

Memory 120 is a physical device used to store programs (sequences of instructions) or data (e.g. program state information) on a temporary or permanent basis. Memory 120 is connected to processor 110, radio 130 and port 150.

Radio 130 is a wireless transmission device used for transmitting and receiving signals via antenna 140 through free space by electromagnetic radiation of a frequency significantly below that of visible light, in the radio frequency range, from about 30 kHz to 300 GHz, which are commonly known as radio waves. Information is carried by systematically changing (modulating) some property of the radiated waves, such as, but is not limited to amplitude, frequency, phase, or pulse width. When radio waves strike an electrical conductor, the oscillating fields induce an alternating current in the conductor. The information in the radio waves can be extracted and transformed back into its original form. Radio 130 can operate according to at least one point-to-point, or peer-to-peer wireless protocol, such as, but is not limited to, MiWi, Bluetooth, Bluetooth Low Energy (BLE), Wi-Max, CDMA, TDMA, RFID, Satellite, etc.

Antenna 140 is an electrical device which converts electric power into radio waves, and vice versa. It is usually used with a radio transmitter or radio receiver. In transmission, a radio transmitter supplies an oscillating radio frequency electric current to the antenna's terminals, and the antenna radiates the energy from the current as electromagnetic waves (radio waves). In reception, an antenna intercepts some of the power of an electromagnetic wave in order to produce a tiny voltage at its terminals that is applied to a receiver to be amplified. Antenna 140 can transmit and receive signals according to at least one point-to-point, or peer-to-peer wireless protocol, such as, but is not limited to, MiWi, Bluetooth, Bluetooth Low Energy (BLE), Wi-Max, CDMA, TDMA, RFID, Satellite, etc.

Port 150 is an electro-mechanical device for joining electrical and/or data circuits as an interface using a mechanical assembly. Only one port 150 is shown in FIG. 1A for clarity, but transponder 100 may include additional port 150s. Port 150 can be designed to plug into an On Board Diagnostic Module 300 (as shown in FIGS. 3A, 3B), in order to capture information from a high value asset, such as an automobile, or Vehicle Identification Number (VIN), Calibration ID (CALID), etc., for identification, authentication, and/or audit purposes.

Transponder 100 can be used to determine position within a positioning system also. If transponder 100 includes a GPS transceiver, or can tap into a vehicle's GPS system, location can be determined. Optionally, transponder 100 can use a hybrid positioning system to determine position, using any combination of MiWi signals, cell tower signals, Wi-Fi signals, Bluetooth, etc. In addition, the hybrid positioning system can also be incorporated with a GPS system.

FIG. 1B illustrates another embodiment of Transponder 101 designed to emit a unique identifier associated with an asset that is part of the integrated solution described in the present invention for transponder-based vehicle services. Transponder 101 may be designed to include its own unique identifier, such as, but not limited to, MAC-48 addresses, EUI-64 addresses, IP addresses, RFID identifiers, Electronic Serial Numbers (ESN), International Mobile Equipment Identifiers (IMEI), Mobile Equipment Identifiers (MEI), International Mobile Subscriber Identity (IMSI), etc. Transponder 101s unique identifier may be cross-referenced to a vehicle's unique identifier, such as, but not limited to, a VIN, CALID, etc. The unique identifier of Transponder 101 may be the only unique identifier collected in an audit, which is cross-referenced by the method of the present invention to the associated unique identifier of the associated vehicle, or piece of machinery.

Transponder 101 is designed to be plugged into all the ports of an OBD module (as shown in FIGS. 3A, 3B).

Transponder 101 consists of the following components, processor 110, memory 120, radio 130, antenna 140, and port 150. Transponder 101 is designed to be inserted into all the ports on a vehicle OBD module (not shown), allowing the OBD module (not shown) to be plugged into for normal vehicle diagnostics without removing transponder 101. The functionality of transponder 101 is integrated into its form factor to perform the functions of the present invention while allowing the OBD ports to pass thru data.

Processor 110 incorporates the functions of a central processing unit (CPU) on at least one integrated circuit. Processor 110 accepts digital data as input, processes it according to instructions stored in memory 120, and provides results as output.

Memory 120 is a physical device used to store programs (sequences of instructions) or data (e.g. program state information) on a temporary or permanent basis. Memory 120 is connected to processor 110, radio 130, and port 150.

Radio 130 is a wireless transmission device used for transmitting and receiving signals via antenna 140 through free space by electromagnetic radiation of a frequency significantly below that of visible light, in the radio frequency range, from about 30 kHz to 300 GHz, which are commonly known as radio waves. Information, is carried by systematically changing (modulating) some property of the radiated waves, such as, but not limited to amplitude, frequency, phase, or pulse width. When radio waves strike an electrical conductor, the oscillating fields induce an alternating current in the conductor.

The information in the radio waves can be extracted and transformed back into its original form. Radio 130 can operate according to at least one point-to-point, or peer-to-peer wireless protocol, such as, but not limited to, MiWi, Bluetooth, Bluetooth Low Energy (BLE), Wi-Max, CDMA, TDMA, RFID, Satellite, etc.

Antenna 140 is an electrical device which converts electric power into radio waves, and vice versa. It is usually used with a radio transmitter or radio receiver. In transmission, a radio transmitter supplies an oscillating radio frequency electric current to the antenna's terminals, and the antenna radiates the energy from the current as electromagnetic waves (radio waves). In reception, an antenna intercepts some of the power of an electromagnetic wave in order to produce a tiny voltage at its terminals that is applied to a receiver to be amplified. Antenna 140 can transmit and receive signals according at least one point-to-point, or peer-to-peer wireless protocol, such as, but is not limited to, MiWi, Bluetooth, Bluetooth Low Energy (BLE), Wi-Max, CDMA, TDMA, RFID, Satellite, etc.

OBD Male Bank Of Ports 170 is an electro-mechanical device for joining electrical and/or data circuits as an interface using a mechanical assembly. OBD Male Bank Of Ports 170 is designed to plug into all of ports of On Board Diagnostic Module 300 (as shown in FIGS. 3A, 3B), in order to capture information from a high value asset, such as an automobile, or Vehicle Identification Number (VIN), Calibration Identifier (CALID), etc., for identification, authentication, and/or automatic or semi-automatic audit purposes, while simultaneously allowing for normal operation in a pass-through mode of the On Board Diagnostic Module 300 (as shown in FIGS. 3A, 3B) for vehicle diagnostic purposes.

OBD Female Bank Of Ports 180 is an electro-mechanical device for joining electrical and/or data circuits as an interface using a mechanical assembly. OBD Female Bank Of Ports 180 is designed to allow all the ports of an On Board Diagnostic Module 300 (not shown), to be connected to On Board Diagnostic Module 300 (not shown) via OBD Male Bank Of Ports 170 while simultaneously allowing transponder 101 to perform the necessary functions in a pass-through mode of the present invention, such as, but not limited to capturing the VIN, CALID, etc., for identification, authentication, and/or automatic or semi-automatic audit purposes.

Transponder 101 can be used to determine position within a positioning system also. If transponder 101 includes a GPS transceiver, or can tap into a vehicles GPS system, location and timestamp can be determined. Optionally, transponder 101 can use a hybrid positioning system, including Assisted GPS (A-GPS), to determine position, using any combination of MiWi signals, cell tower signals, Wi-Fi signals, Bluetooth, etc. In addition, the hybrid positioning system can also be incorporated with a GPS system.

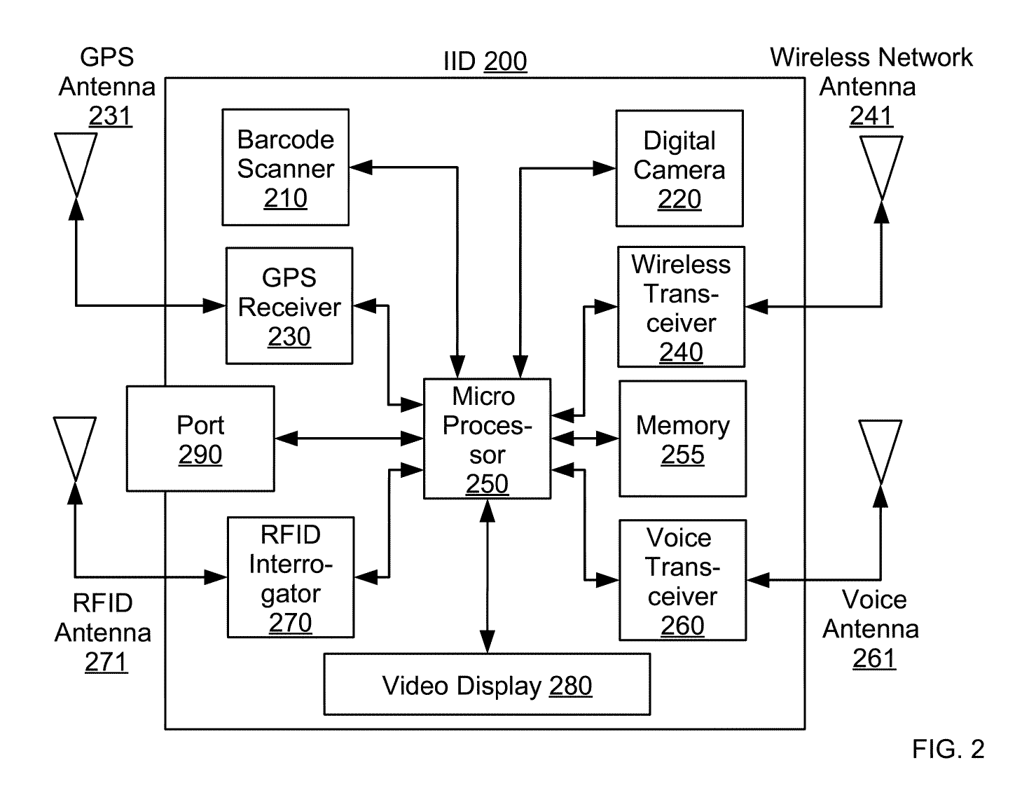

FIG. 2 is a high-level block diagram of IID 200 contained in a housing of a single form factor which is part of the integrated solution of the present invention for transponder and/or wired plug-in vehicle services. IID 200 can also be configured as an enabled laptop, netbook, tablet, smart phone, or other device, or combination of devices such as, but not limited to, a wireless access point connected to a remote back-end system. The software, firmware, or hardware of a specific IID 200 may contain a private device code as a means to identify a specific IID 200, or if the functionality of the IID 200 is configured as a tablet, smart phone, or other device, the device code can be a number such as, but not limited to, the International Mobile Subscriber Identity (IMSI) and the related key used to identify and authenticate subscribers on mobile telephony networks using the integrated circuit on an enabled tablet's or smart phone's Subscriber Identification Module (SIM).

The IID 200 is comprised of the following functional items including, but not limited to, a microprocessor 250, memory 255, video display 280, and a data port 290. Optionally, it may include the following, but is not limited to, a barcode scanner 210, digital camera 220, GPS receiver 230 and GPS antenna 231, a wireless transceiver 240 and wireless network antenna 241, a RFID interrogator 270 and RFID antenna 271, and a voice transceiver 260 and voice antenna 261.

Microprocessor 250 may be built on hardware including, but not limited to, Field Programmable Gate Arrays (FPGA), Application Specific Integrated Circuits (ASIC), System-On-A-Chip (SoC), etc.

Analog data is sent to an analog-to-digital converter and converted to Digital data and sent to the microprocessor 250. The microprocessor 250 packs the digital data so that it can be read by microprocessor 250. Microprocessor 250 is connected to memory 255, which may be embedded on microprocessor 250 which increases the speed of the IID 200. The microprocessor 250 operates under the control of a program stored in memory 255 via an external data and address bus. Interaction between the IID 200 which may incorporate a barcode scanner 210 may be provided using a host interface.

The IID 200 may also contain an optional RFID interrogator 270 which sends out a radio frequency wave to transponder designed to emit a unique identifier associated with an asset and in return, transponder designed to emit a unique identifier associated with an asset broadcasts back its stored data to the RFID interrogator 270. The data collected from a transponder designed to emit a unique identifier associated with an asset can either be sent directly to a host computer through standard interfaces, or it can be stored in a portable transceiver and later uploaded to the computer for data processing.

The optional RFID interrogator 270 receives analog signals, processes them using an analog-to-digital converter, and sends the digital signals to microprocessor 250.

The microprocessor 250 packs the digital data so that it can be read. Microprocessor 250 is connected to memory 255, which may be embedded on microprocessor 250 which increases the speed of the IID 200. The microprocessor 250 operates under the control of a program stored in memory 255 via an external data and address bus. Interaction between the IID 200 which incorporates the RFID interrogator 270 may be provided using a host interface. The microprocessor 250 may use an operating system such as, but not limited to, Android, Apple iOS, Microsoft Windows, Linux, etc.

The IID 200 may optionally include a digital camera 220, which can be used to capture an image of a high value asset. In addition, IID 200 may optionally include a GPS receiver 230, which may be used to verify the position of an IID 200. IID 200 may also include a wireless transceiver 240 capable of transmitting/receiving using Wireless Protocols, such as but is not limited, to MiWi, Bluetooth, Bluetooth Low Energy (BLE), Wi-Fi, etc.

IID 200 may optionally include a voice transceiver 260 for connection to a network operating on standards, such as, but is not limited to a CDMA, TDMA, GSM, etc. The voice transceiver 260 can also be used to transmit data.

Only one data port 290 is shown for clarity, but IID 200 may include additional ports. These ports may include, but not limited to an RJ-11 jack for telephone twisted pair, an RJ-45 jack for an Ethernet connection, IEEE 1394 Fire Wire connection, USB, RS-232, etc. This port can be used to by-pass transponder 100 and plug into ODB Module 300 directly to obtain the VIN, CALID, etc.

FIG. 3A is an illustration of the system of the present invention for transponder-based vehicle services. OBD Module 300 refers to an On-Board Diagnostics System, or OBD, which is an automotive term referring to a vehicle's self-diagnostic and reporting capability. OBD systems give a vehicle owner or a repair technician access to state of health information for various vehicle sub-systems. Modern OBD implementations use a standardized communications port to provide real-time data in addition to a standardized series of Diagnostic Trouble Codes (DTCs) and System Readiness Tests (SRTs) which allow one to rapidly identify and remedy malfunctions within the vehicle.

One protocol for OBD is OBD-II, which is widely deployed, and an improvement over OBD-I in both capability and standardization. The OBD-II standard specifies the type of diagnostic connector and its pin-out, the electrical signaling protocols available, and the messaging format. It also provides a candidate list of vehicle parameters to monitor along with how to encode the data for each. There is a pin in the connector that provides power for the scan tool from the vehicle battery, which eliminates the need to connect a scan tool to a power source separately. Finally, the OBD-II standard provides an extensible list of Parameter Identification (PIDs) registers. As a result of this standardization, a single device can query the on-board computer(s) in any vehicle. OBD-II came in two models OBD-IIA and OBD-IIB. OBD-II standardization was prompted by emissions requirements, and though only emission-related codes and data are required to be transmitted through it, most manufacturers have made the OBD-II Data Link Connector the only one in the vehicle through which all systems are diagnosed and programmed.

The OBD-II specification provides for a standardized hardware interface—the 16-pin (2×8) J1962 connector.

As an example in Chart 1, one standard OBD-II PID (Parameter ID), Mode $09, PID 02 returns the Vehicle Identification Number (VIN):

CHART 1

| Mode | PID | Data Bytes | | Min | Max | | |
|---|---|---|---|---|---|---|---|
| (Hex) | (Hex) | Returned | Description | Value | Value | Units | Formula |
| 09 | 02 | 5 × 5 | VIN | | | | Returns the VIN as a |
| | | | | | | | multi-frame response |
| | | | | | | | using the ISO 15765-2 |
| | | | | | | | protocol. This is typically |
| | | | | | | | five frames, with the first |
| | | | | | | | frame encoding the size |
| | | | | | | | and count. |

The VIN PID for any OBD-type protocol is used to accomplish the primary object of the present invention for transponder and/or wired plug-in vehicle services, which is described in the attachments related to the present invention for transponder and/or wired plug-in vehicle services.

Automatic or semi-automatic audits for inventory control are but one example of using the present invention. Many other uses exist including, but not limited to, management of storage and transportation logistics; sales force access to history and valuation reports, sales force access to product comparisons; granting permission for test drives; providing a means for post-sales connections of a dealer-to-customer-to-vehicle; and auto auction applications including, but not limited to, pre-sale reconditioning data, display and staging logistics, providing dealer access to history, valuation, and comparison reports, granting permission for dealer test drives, law enforcement vehicle verification, and providing an auction recap to dealers. The IID 200, as shown in FIG. 2, is within the broadcast range of transponder 100, which is designed to emit a unique identifier associated with an asset, said identifier may be an alpha-numeric identifier, such as, but not limited to a Vehicle Identification Number (VIN), Calibration Identifier (CALID), etc., which is used to indicate the authenticity of the location of a high value asset being audited. The transponder 100 can also be used as portable database to store and record data that is relevant to a specific high value asset.

The present invention's database (not shown) may contain the names of dealers and a dynamic list of vehicles they have financed (floor planned). The present invention's database (not shown) could be programmed to remotely audit a dealer's inventory at any given time with at least one fixed or mobile position IID 200.

In order to perform a remote audit, at least one fixed or mobile IID 200 would scan at least one transponder 100 designed to emit a unique identifier, such as, but not limited to a VIN, CALID, etc., obtained from an OBD Module 300 on a vehicle, which is listed in the present invention's database (not shown), which has been wirelessly transmitted from transponder 100 to at least one fixed or mobile IID 200, which has been transmitted to the present invention's database (not shown).

In FIG. 3B the transponder 101 is designed to be connected to an OBD Module 300 in a vehicle. The IID 200 is used to communicate wirelessly with transponder 101 to retrieve a VIN, CALID, etc., via the OBD Module 300 it is connected to. The IID 200 is also capable of correlating, within a few feet, the globally referenced position of a vehicle by using an optional GPS receiver on the IID 200, or by use of a hybrid positioning system technology to locate the IID 200 and transponder 101 via a either a fixed or moving frame of reference.

The transponder 101 can also be used as portable database to store and record data that is relevant to a specific high value asset.

The present invention's database (not shown) may contain the names of dealers and a dynamic list of vehicles they have financed (floor planned). A program could be programmed to randomly instruct the database (not shown) to select the dealers to be audited at any given time. In order to perform an audit, the IID 200 would scan each transponder 101 designed to emit a unique identifier, such as, but not limited to a VIN, CALID, etc., obtained from an OBD Module 300 on a vehicle. The code contained in transponder 101 is captured using an IID 200, or enabled tablet, smart phone, or other device, or alternatively the combination of a wireless access point connected to a remotely located back-end computer system. Once the present invention's database has analyzed the results of an audit it will output a report.

Chart 3 includes descriptions of the present invention as previously described in FIGS. 1A, 1B, 2, 3A, and 3B, as well as other embodiments of the present invention, including, but not limited to,

CHART 3

| CONFIGURATION | DESCRIPTION |
|---|---|
| Transponder Plugs Into Single Port Of | Transponder Requests VIN or CALID Thru |
| OBD Module | Vehicle OBD Module, And Wirelessly |
| | Transmits VIN Via An Integrated Transceiver |
| Transponder Is Integrated | Transponder Requests VIN Thru Vehicle OBD |
| Into A Form Factor That Is Designed To | Module, And Wirelessly Transmits VIN or |
| Plug Into All The Ports Of An OBD | CALID Via An Integrated Transceiver |
| Module To Allow The OBD Module To | |
| Operate Normally In A Pass-Through | |
| Mode For Diagnostic Functions While | |
| Simultaneously Performing The Functions | |
| Of The Present Invention | |
| Transponder Plugs Into Single Port Of | Transponder Requests VIN Thru Vehicle OBD |
| OBD Module | Module, And Wirelessly Transmits VIN or |
| | CALID Via An In-Car Entertainment System's |
| | Wireless Capability |
| Transponder Is Integrated Into A Form | Transponder Requests VIN Thru Vehicle OBD |
| Factor That Is Designed To Plug Into All | Module, And Wirelessly Transmits VIN or |
| The Ports Of OBD Module To Allow The | CALID Via An In-Car Entertainment System's |
| OBD Module To Operate Normally In A | Wireless Capability |
| Pass-Through Mode For Diagnostic | |
| Functions While Simultaneously | |
| Performing The Functions Of The Present | |
| Invention | |
| Transponder Plugs Into Single Port Of | Transponder Requests VIN or CALID Thru |
| OBD Module | Vehicle OBD Module, And Wirelessly |
| | Transmits VIN or CALID Via Vehicle's |
| | Subscriber Based Service |
| Transponder Is Integrated Into A Form | Transponder Requests VIN or CALID Thru |
| Factor That Is Designed To Plug Into All | Vehicle OBD Module, And Wirelessly |
| The Ports Of OBD Module To Allow The | Transmits VIN or CALID Via Vehicle's |
| OBD Module To Operate Normally In A | Subscriber Based Service |
| Pass-Through Mode For Diagnostic | |
| Functions While Simultaneously | |
| Performing The Functions Of The Present | |
| Invention | |
| No Transponder. The Transponder | Vehicle Subscriber Based Service Requests VIN |
| Function Programmed Into A Vehicle's | Thru Vehicle OBD Module And Wirelessly |
| Subscriber Based Service | Transmits VIN Via Vehicle's Subscriber Based |
| | Service Wireless Connection To A Remotely |
| | Located Back-End System |
| No Transponder. The Transponder | Vehicle Subscriber Based Service Requests VIN |
| Function Programmed Into A Vehicle's | or CALID Thru Vehicle OBD Module And |
| Subscriber Based Service | Wirelessly Transmits VIN or CALID Via |
| | Vehicle's Non-Subscriber Based Service |
| | Wireless Connection To A Remotely Located |
| | Back-End System |
| Wire Plugs Into Single Port Of OBD | Smart Phone Connected To Wire Requests VIN |
| Module | Thru Vehicle OBD Module, And Wirelessly |
| | Transmits VIN or CALID Via An Integrated |
| | Transceiver |
| Wire Is Integrated | Smart Phone Connected To Wire Requests VIN |
| Into A Form Factor That Is Designed To | Thru Vehicle OBD Module, And Wirelessly |
| Plug Into All The Ports Of An OBD | Transmits VIN Via An Integrated Transceiver |
| Module To Allow The OBD Module To | |
| Operate Normally In A Pass-Through | |
| Mode For Diagnostic Functions While | |
| Simultaneously Performing The Functions | |
| Of The Present Invention | |
| Wire Plugs Into Single Port Of OBD | Smart Phone Connected To Wire Requests VIN |
| Module | Thru Vehicle OBD Module, And Wirelessly |
| | Transmits VIN or CALID Via An In-Car |
| | Entertainment System's Wireless Capability |
| Wire Is Integrated Into A Form Factor That | Smart Phone Connected To Wire Requests VIN |
| Is Designed To Plug Into All The Ports Of | or CALID Thru Vehicle OBD Module, And |
| OBD Module To Allow The OBD Module | Wirelessly Transmits VIN or CALID Via An In- |
| To Operate Normally In A Pass-Through | Car Entertainment System's Wireless Capability |
| Mode For Diagnostic Functions While | |
| Simultaneously Performing The Functions | |
| Of The Present Invention | |
| Wire Plugs Into Single Port Of OBD | Smart Phone Connected To Wire Requests VIN |
| Module | or CALID Thru Vehicle OBD Module, And |
| | Wirelessly Transmits VIN or CALID Via |
| | Vehicle's Subscriber Based Service |
| Wire Is Integrated Into A Form Factor That | Smart Phone Connected To Wire Requests VIN |
| Is Designed To Plug Into All The Ports Of | or CALID Thru Vehicle OBD Module, And |
| OBD Module To Allow The OBD Module | Wirelessly Transmits VIN Via Vehicle's |
| To Operate Normally In A Pass-Through | Subscriber Based Service |
| Mode For Diagnostic Functions While | |
| Simultaneously Performing The Functions | |
| Of The Present Invention | |

Generally, the initial roll-out of the present invention is a point-to-point system architecture. In this configuration, the transponder extracts unique identifiers associated with a particular vehicle, and the data is communicated wirelessly from the transponder to a mobile device, which in turn relays the collected information to a remote location for verifying the authenticity of the asset. This embodiment for identifying and authenticating the presence of high value, collateralized assets at remote locations; includes obtaining asset identification through an electronically read apparatus and communicated back to remote location for authenticity verification, otherwise known as remote, floor plan self-auditing. The system incorporates an identified asset with OBDII compliant port, a point to point communication protocol such as Bluetooth, Wifi, Zigbee, etc. enabled electronic apparatus with standard OBDII connection, web-enabled laptop, netbook, mobile phone or tablet (mobile device) with camera and remote operator which usually dealer staff. The methodology requires the asset owner's (financial party) request for asset verification to the dealer (lender). The audit request is received by the remote operator (dealer) via a smart phone which is Bluetooth equipped to communicates with the OBD smart device through the web browser or custom application. The operator locates each specific asset and attaches the electronic apparatus to the OBDII port. The apparatus retrieves asset specific information and transmits this information to the mobile device. The OBD apparatus is then removed from the asset and the specific asset information, time-stamp, GPS coordinates and asset image are procured via the mobile device which is the submitted through the web/cloud portal to the “risk management” bureau for remote verification.

In the second phase roll-out of the present invention is characterized by a peer-to-peer network architecture. This phase consists of similar OBD modules that will remain in the OBD port of all assets so that “real time” identification and other related benefits can be derived on a 24/7 basis by a dealer, his staff, his customers, financial companies, auction companies and their customers, etc. In this network architecture scenario for identifying and authenticating the presence of high value, collateralized assets at remote locations; includes obtaining unique asset specific information through a network apparatus, an electronically read apparatus and communicated back to a remote location for authenticity verification. The system incorporates an identified asset with OBDII compliant port, network gateway and a wireless network enabled electronic apparatus with standard OBDII connection. The methodology requires the remote location to possess a system's network gateway and have an electronic apparatus on all assets requiring remote authentication. The assets' financial lender can submit requests for asset verification via web on an anytime, real time basis. The system manages the connectivity of the assets which contain the OBD device for any time, real time, unique asset information, time-stamp, GPS coordinates through the gateway and can also be provided on an any time, real time basis to the dealer, their staff, their customers or provide beneficial services for auctions, rental companies and others companies to obtain any time, real time access information relative to high value assets, immediately upon request 24/7 or at scheduled time frequencies.

There are many other uses for the present invention during the Life-Cycle of a Vehicle.

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory. Functions performed by a single system component may instead be performed by multiple components, and functions performed by multiple components may instead performed by a single component.

Unless specifically stated otherwise, as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware, or hardware, and when embodied in software, could be downloaded to reside on and be operated from different platforms. Furthermore, the computers referred to in the specification may include a single processor or may be architectures employing multiple processor designs for increased computing capability.

The scope of this invention should be determined by the appended claims and their legal equivalents, rather than by the examples given.

What is claimed is:

1. A method comprising:
providing an electronic module configured to retrieve vehicle specific data associated with a vehicle;
obtaining the vehicle specific data from the vehicle using the electronic module;
wirelessly bi-directionally communicating the vehicle specific data with one or more mobile devices near the vehicle.

2. The method of claim 1 wherein the electronic module is configured to retrieve data from an OBD port of the vehicle through the OBD port.

3. The method of claim 2 wherein the vehicle specific data comprises vehicle identification number (VIN).

4. The method of claim 2 wherein the vehicle specific data comprises calibration identification (CALID) data.

5. The method of claim 1 further comprising:
inserting the electronic module into the vehicle;
sending vehicle specific data to the electronic module;
storing the vehicle specific data in the electronic module while the electronic module is in the vehicle such that the vehicle specific data is not present when the electronic module is removed from the vehicle.

6. The method of claim 5 wherein the vehicle provides power to the electronic module while the electronic module is connected to the vehicle.

7. The method of claim 1 further comprising analyzing the vehicle specific data.

8. The method of claim 7 wherein the analyzing comprises determining whether or not a party to a financing agreement is in compliance with the financing agreement using the vehicle specific data.

9. The method of claim 7 wherein the analyzing comprises performing at least one of inventory control, inventory mapping, and theft deterrence using the vehicle specific data.

10. The method of claim 1 further comprising providing a mobile app for use on the one or more mobile devices, wherein the mobile app is configured to use the vehicle specific data as input.

11. The method of claim 10 further comprising receiving the vehicle specific data as input into the mobile app and communicating the vehicle specific data over a communications network to a remote server.

12. The method of claim 11 further comprising performing a remote audit using the vehicle specific data.

13. The method of claim 10 further comprising acquiring photographs or videos of the vehicle using one or more of the mobile devices near the vehicle and communicating the photographs or videos of the vehicle to the remote server.

14. The method of claim 13 further comprising performing a remote audit using the vehicle specific data and the photographs or the videos.

15. The method of claim 14 wherein the server provides a lender portal and a borrower portal.

16. A system comprising:
providing an electronic module configured to retrieve vehicle specific data associated with a vehicle, wherein the electronic module bi-directionally communicates the vehicle specific data while the electronic module is interfaced with the vehicle and only while the electronic module is interfaced with the vehicle;
interfacing the electronic module to the vehicle; and
communicating the vehicle specific data from the vehicle to a cloud-based server.

17. The system of claim 15 wherein the step of bi-directionally communicating the vehicle specific data from the vehicle to the cloud-based server comprises bi-directional, wirelessly communicating the vehicle specific data to the cloud-based server through a wireless router in operative communication with the electronic module.

18. The system of claim 15 wherein the step of bi-directionally communicating the vehicle specific data from the vehicle to the cloud-based server comprises bi-directional, wirelessly communicating the vehicle specific data to a mobile device executing a mobile app and wirelessly communicating the vehicle specific data through the mobile app to the cloud-based server.

19. The system of claim 17 wherein the mobile app is further configured to receive photos and/or videos of the vehicle and communicate the photos and/or videos of the vehicle to the cloud-based server.
